(19) United States
(12) Patent Application Publication
(10) Pub. No.: US 2013/0232254 A1
(43) Pub. Date: Sep. 5, 2013

(54) CLOUD RESOURCE UTILIZATION MANAGEMENT

(71) Applicants: Munirathnam Srikanth, Bellevue, WA (US); Steve Jamieson, Bellevue, WA (US)

(72) Inventors: Munirathnam Srikanth, Bellevue, WA (US); Steve Jamieson, Bellevue, WA (US)

(73) Assignee: COMPUTENEXT INC., Bellevue, WA (US)

(21) Appl. No.: 13/570,002

(22) Filed: Aug. 8, 2012

Related U.S. Application Data
(60) Provisional application No. 61/606,279, filed on Mar. 2, 2012.

(51) Int. Cl. H04L 12/26

(52) U.S. Cl. CPC H04L 43/0876
USPC 709/224

(57) ABSTRACT

User are alerted by software and hardware when the in-use dynamic computing resources are underutilized so as to allow the user to effectively contain and reduce the operating cost of computing resources' services and application. The software categorizes and publishes workloads and suggests low cost alternatives to the user so as to match a user search criteria or usage pattern of computing resources or workloads.

### CROSS-REFERENCE TO RELATED APPLICATION

This application claims the benefit of Provisional Application No. 61/606,279, filed Mar. 2, 2012, which is incorporated herein by reference.

### TECHNICAL FIELD

The present subject matter is related to software, and more particularly, it relates to cloud computing.

### BACKGROUND

Cloud computing promises the availability of low cost computing resources that can be dynamically allocated upon request vis-à-vis pay-as-you-go policies which charge users upon utilization of the requested computing resources. In practice, users turn on requested computing resources for utilization but neglect to turn them off, thereby incurring continuous charges. Thus, the discipline required to maintain a low cost operation is lacking. Lacking the discipline to turn off causes users to end up overpaying for underutilized computing resources. Also, there is a lack of information and knowledge among consumers to select computing resources during capacity planning in an efficient way.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

One aspect includes a method form of the present subject matter which recites a method for managing utilization of resources or workloads. The method comprises monitoring utilization of a computing resource or workload. The method further comprises alerting a user of underutilization of the computing resource or workload. The method additionally comprises either releasing or not releasing the computing resource or workload that is underutilized based on a set of releasing rules.

Another aspect includes a system form of the present subject matter which recites a system for managing utilization of resources or workloads. The system comprises a monitoring agent, being executed on a piece of hardware, to monitor utilization of a computing resource or workload. The system further comprises an alerting agent, being executed on the piece of hardware or another piece of hardware, to alert a user of underutilization of the computing resource or workload. The system additionally comprises a releasing agent, being executed on the piece of hardware or another piece of hardware, to either release or not release the computing resource or workload that is underutilized based on a set of releasing rules.

A further aspect includes a computer-readable medium form of the present subject matter which recites a computer-readable medium. The computer-readable medium is non-transitory and on which computer-executable instructions are stored to implement a method for managing utilization of resources or workloads. The method comprises monitoring utilization of a computing resource or workload. The method further comprises alerting a user of underutilization of the computing resource or workload. The method additionally comprises either releasing or not releasing the computing resource or workload that is underutilized based on a set of releasing rules.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of an archetypical system in accordance with various embodiments of the present subject matter;

FIG. 2 is a pictorial diagram illustrating archetypical computing resources whose utilization is monitored in accordance with various embodiments of the present subject matter;

FIG. 3A is a block diagram of an archetypical system in accordance with various embodiments of the present subject matter;

FIG. 3B is a block diagram of an archetypical system in accordance with various embodiments of the present subject matter; and

FIGS. 4A-4J are process diagrams illustrating an archetypical software method for monitoring and bettering utilization of computing resources or workloads via pieces of hardware in accordance with various embodiments of the present subject matter.

### DETAILED DESCRIPTION

Various embodiments of the present subject matter discuss systemic management and monitoring of computing resources or workload utilization. In addition, a few embodiments provide plan for capacity usage of computing resources or workloads. All embodiments of the present subject matter monitor and analyze utilization of computing resources or workloads in on-demand computing environments, detect any underutilized computing resources, and alert a user to either take action or cause a user agent to take action on behalf of the user through previously programmed intent. Some embodiments are configured to suggest suitable computing resources or workloads to the user during planning for bettering utilization throughout the life cycle of a user computing tasks and workloads. In general, various embodiments capture, monitor, profile, and understand resource utilization, and categorize workloads based on resultant derived data, in federated on-demand computing environments. A number of embodiments facilitate the cost-efficient and well-informed rental of computing resource by consumers and better resource utilization mechanisms for providers as well, in cloud computing paradigm such as Infrastructure-as-a-Service (IaaS), Platform-as-a-Service (PaaS), Software-as-a-Service (SaaS), and Database-as-a-Service (DaaS).

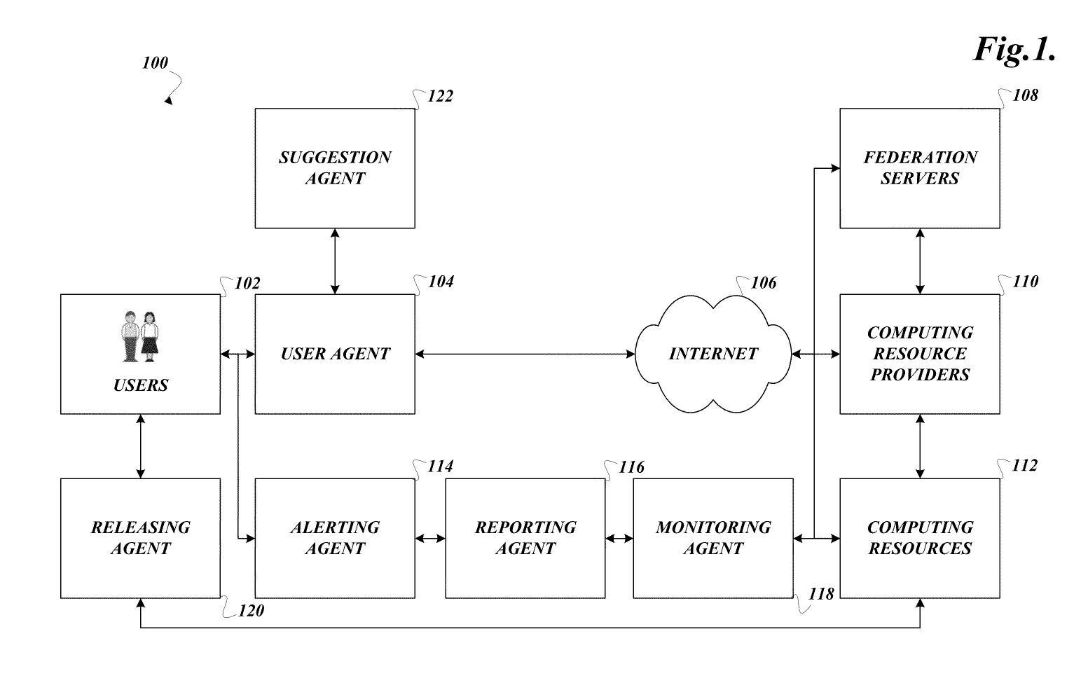

FIG. 1 illustrates a system 100 which is configured to monitor and analyze utilization of computing resources or workloads; profile computing resources or workloads based on utilization according to report templates; detect underutilization based on pre-defined rules; provide a mechanism to report or alert the user in case of underutilization; provide an agent to take action or alert the user to take action in case of underutilization; provide a learning model to categorize computing resources or workloads based on utilization; provide an agent to publish workloads in to various categories; provide a learning model to establish relationships between resource utilization and resource usage and resource capacity; proactively propose suitable computing resource or workload alternatives during capacity planning; provide a set of user tools; and/or provide a backend system. In a group of embodiments, the subject matter comprises a set of application programming interfaces (APIs) that allow the above-referenced features to work together as well as enable other users and their surrogate software user agents to monitor, categorize and publish computing resources or workloads, and propose suitable alternatives.

Returning to the drawings, FIG. 1 illustrates a user agent 104 (as a software component) that acts on behalf of users 102 to peruse computing resources or workloads and select them by communication with federation servers 108 via the Internet 106. Workloads are used to model and represent a user collection of computing resources. Users 102 build a workload by searching for computing resources based on certain attributes. The user agent 104 or the federation servers 108 may interact with computing resource providers 110 or computing resources 112 either indirectly or directly. The user agent 104 helps to select, procure, and provision computing resources from heterogeneous on-demand computing environments, which are formed and operated as a web of computing resources through layers of computing resource federation servers 108. These components of the system 100 may be implemented as software or hardware. If software, they execute on one or more pieces of hardware.

A monitoring agent 118 monitors utilization of computing resources 112 or workloads (not shown). The monitoring agent 118 collects data regarding the utilization of the computing resources 112 or workloads over a period of time. These pieces of collected utilization data are then profiled using various templates so as to produce profiles of the utilization of the computing resources 112 or workloads. Reports can be generated by a reporting agent 116 regarding the collected utilization data and profiles. Using predefined rules for detecting underutilization of computing resources 112 or workloads, an alerting agent 114 notifies users 102. A releasing agent 120 can be activated by the users 102, automatically or manually, to release underutilized computing resources 112 or workloads so as to avoid costs connected with idled computing resources 112 or workloads. In some embodiments, a suggestion agent 122 analyzes the collected utilization data to provide suggestions of suitable computing resources or workloads to the user agent 104 so as to assist users 102 to better select desired computing resources or workloads that are suitable for the computing tasks at hand.

Here is an example of rules provided to the alerting agent 114: alert if the CPU utilization of a workload goes below 15% for more than 1 hour duration and terminate the underutilized virtual machine; and alert if disk utilization of a workload goes below 50% for more than 1 week. Thus, when a workload has CPU utilization less of than 15% for nearly two hours, the system 100 would alert the users 102 (and terminate the underutilized virtual machine if the releasing rules permit such an action). Here is another example: consider a scenario in which a workload implements a Drupal Content Management system with an allocated storage of one terrabyte. Suppose the storage usage does not grow by more than 500 gigabytes for more than a week. This would be less than 50% of disk utilization and the system 100 would raise an alert. This alert provides an opportunity for the users 102 to revisit the disk capacity planning and act appropriately. Now the users 102 can either decrease the allocated disk storage and thereby reduce the workload cost or continue using the same configuration, but in full awareness of the alerted utilization pattern.

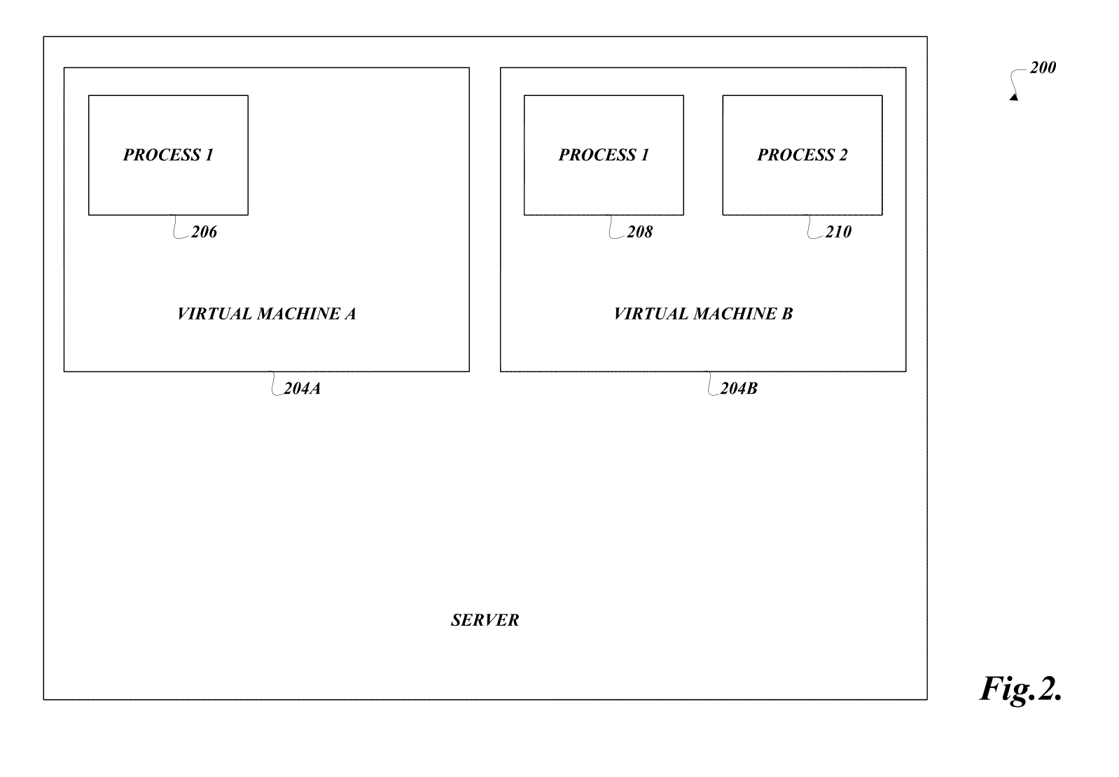

FIG. 2 illustrates a server 200 which is a computing resource that is configured to be monitored by the monitoring agent 118. In a few other embodiments, the monitoring agent 118 may monitor utilization at a level of the virtual machines, such as virtual machine A 204a or virtual machine B 204b. At a deeper level, the monitoring agent 118 may monitor utilization at a process level, such as process 1 206 of virtual machine A 204a or process 1 208 or process 2 210 of virtual machine B 204b. In all embodiments, a software component is suitably installed at one or more levels of the server 200 to monitor desired computing resources.

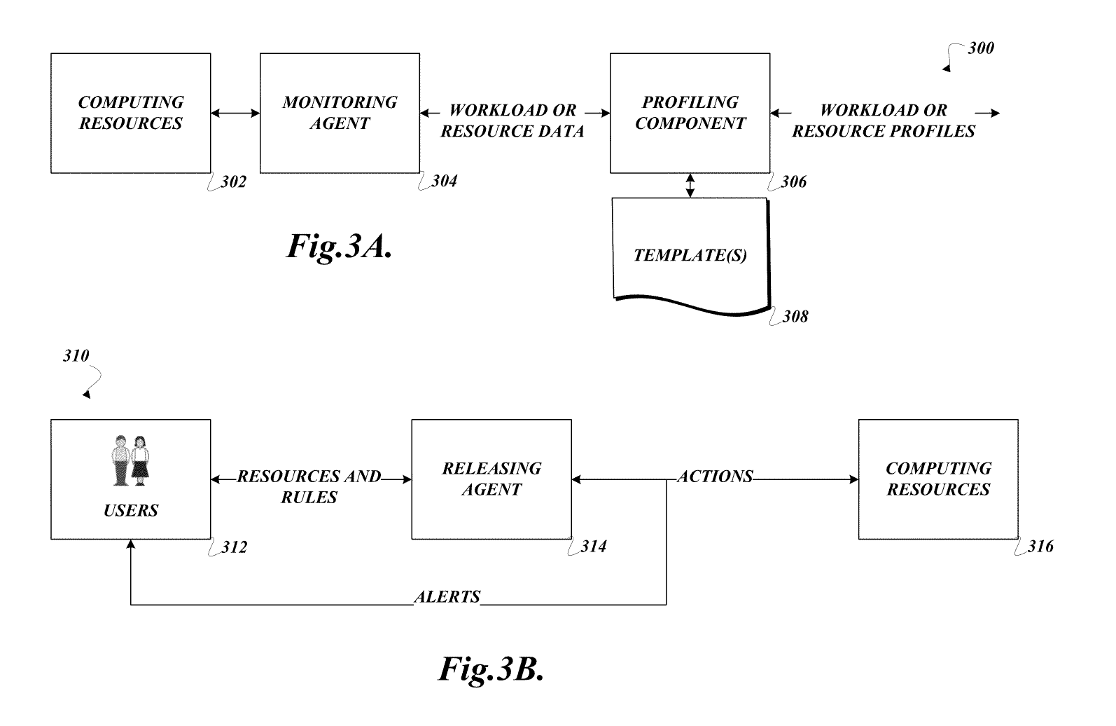

FIG. 3A illustrates a system 300 where a monitoring agent 304 monitors utilization of computing resources 302 or workloads (not shown) and produces workload or resource utilization data. A profiling component 306 receives the workload or resource utilization data and produces workload or resource profiles using one or more templates 308. As indicated previously, such workload or resource profiles are provided to the reporting agent 116. FIG. 3B illustrates a system 310 where a releasing agent 314 receives rules regarding releasing various computing resources or workloads and proceeds to initiate actions, automatically or manually, to release underutilized computing resources 316 or workloads (not shown). The releasing agent 314 may produce alerts to users 312 that the desired underutilized computing resources 316 have been released.

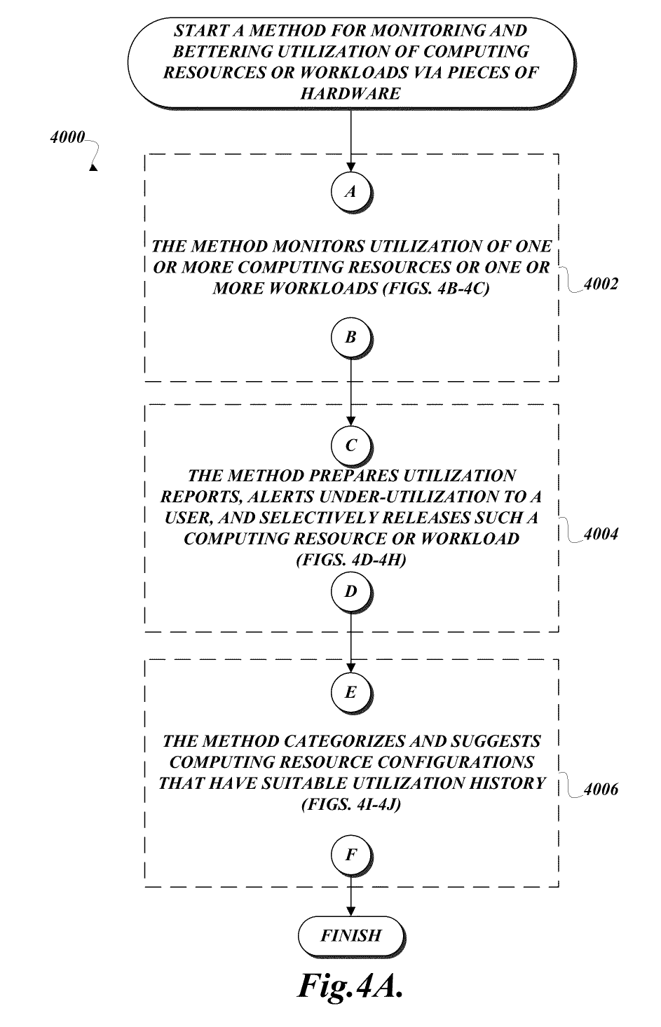

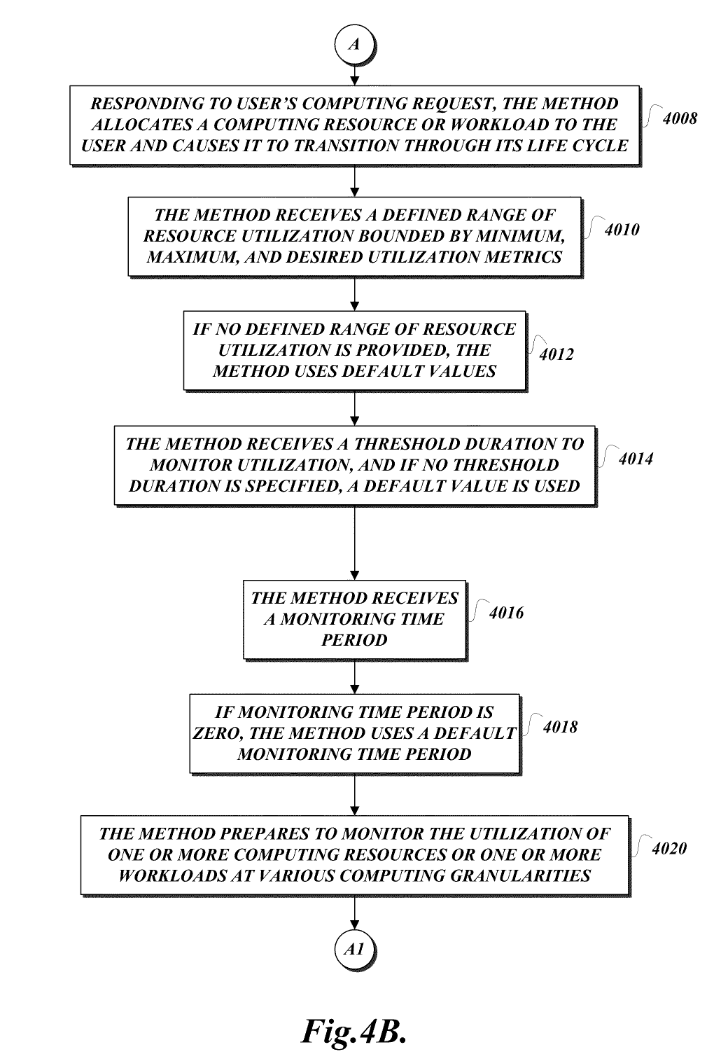

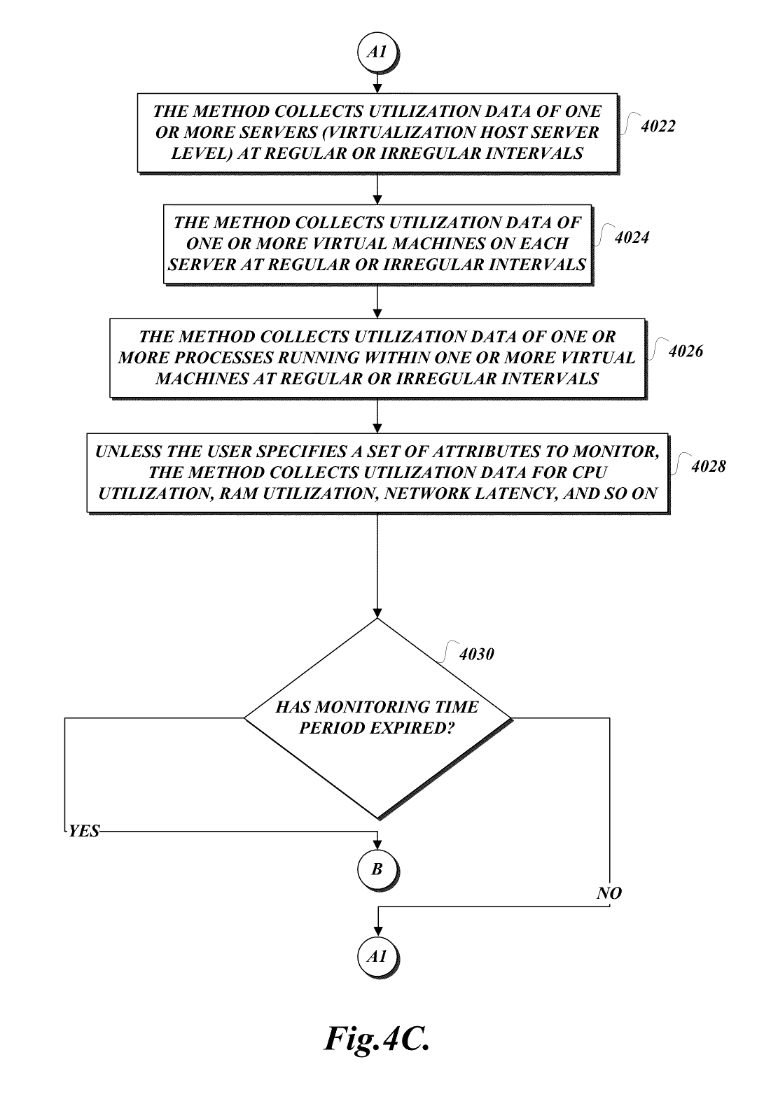

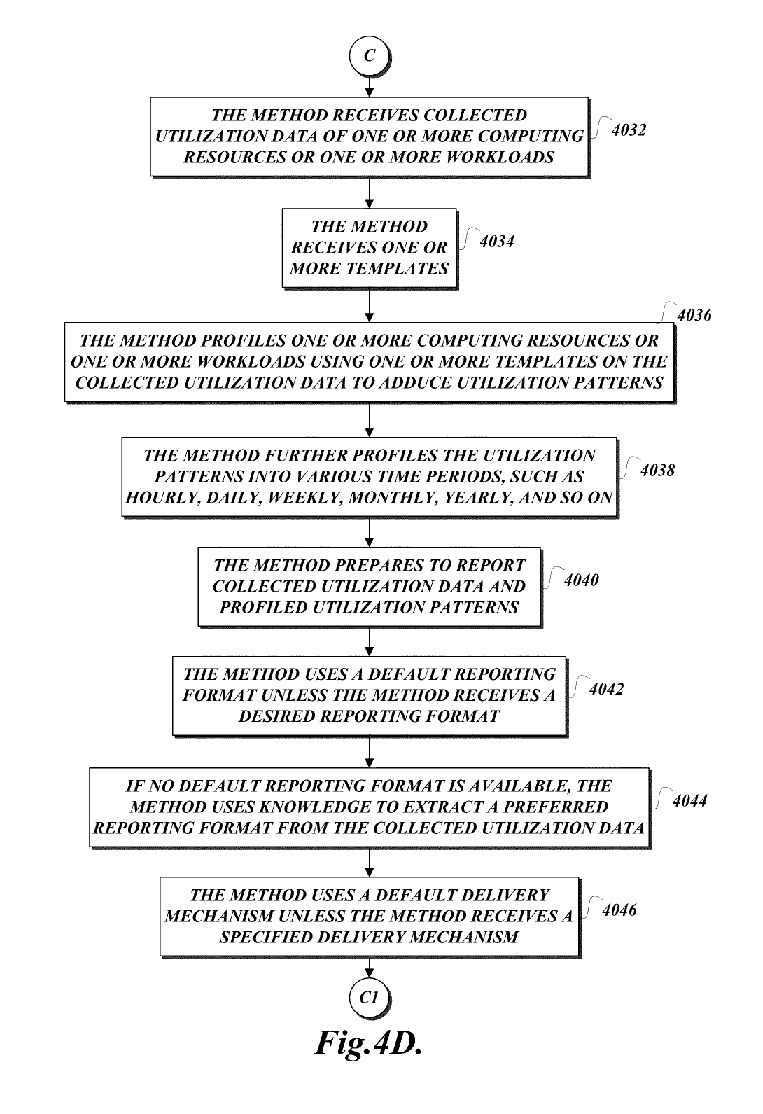

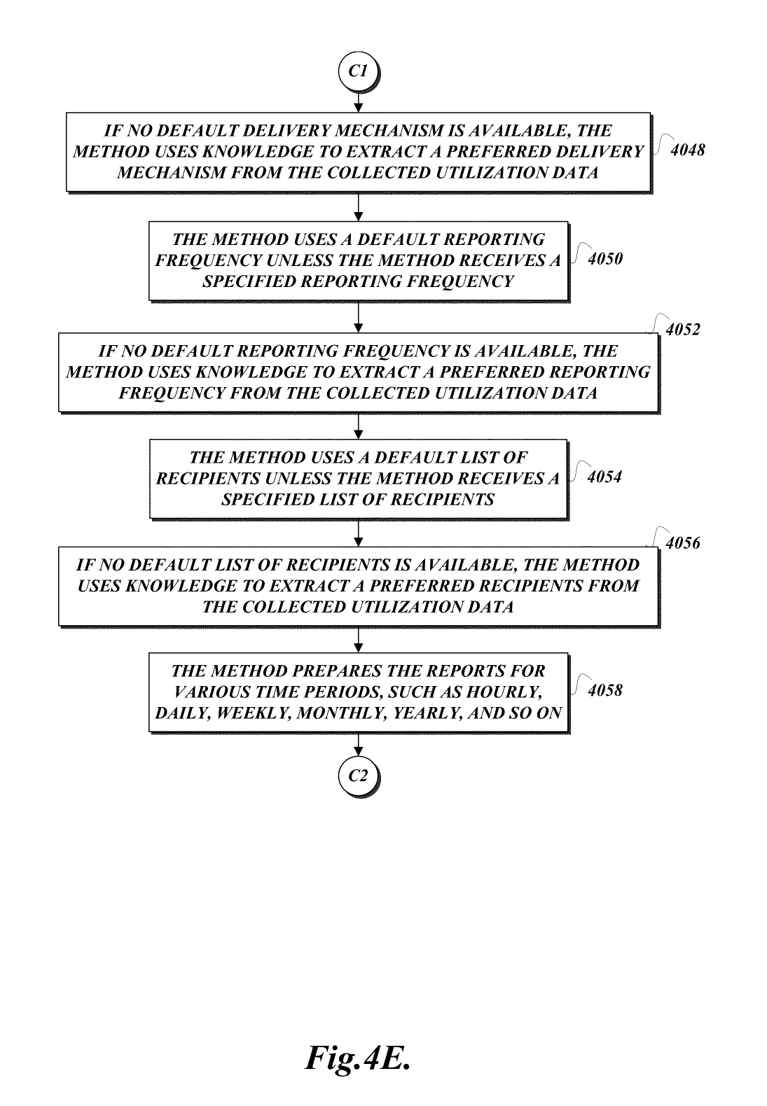

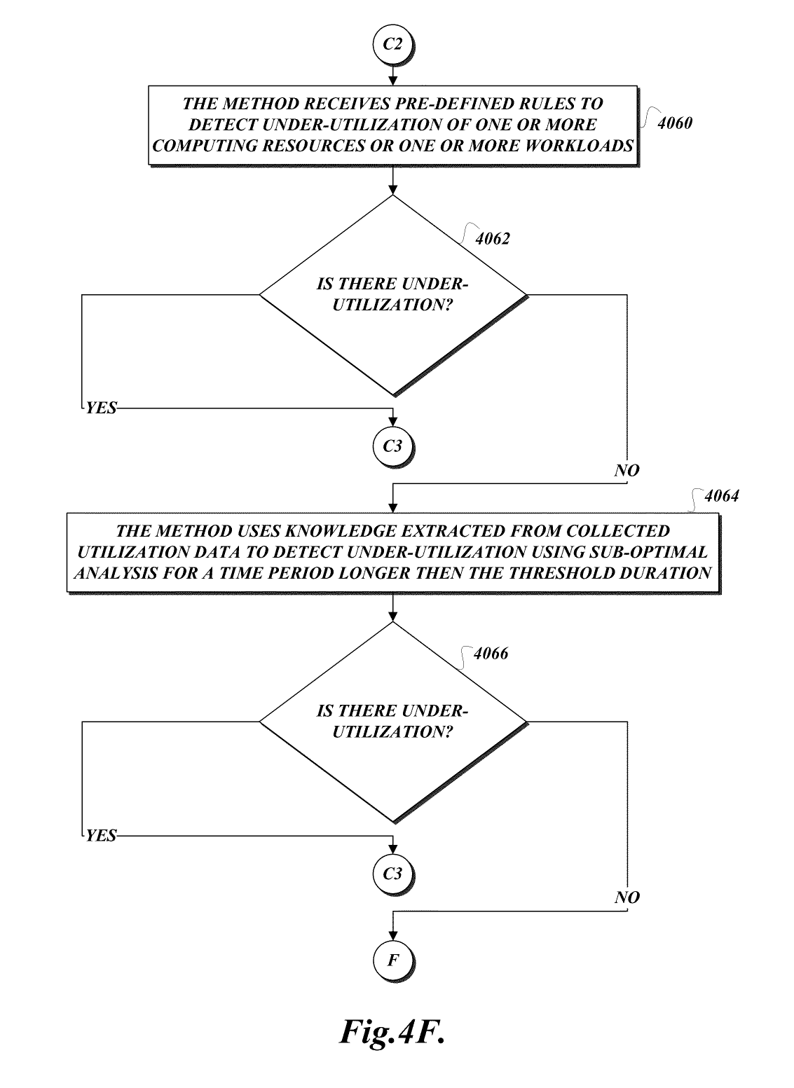

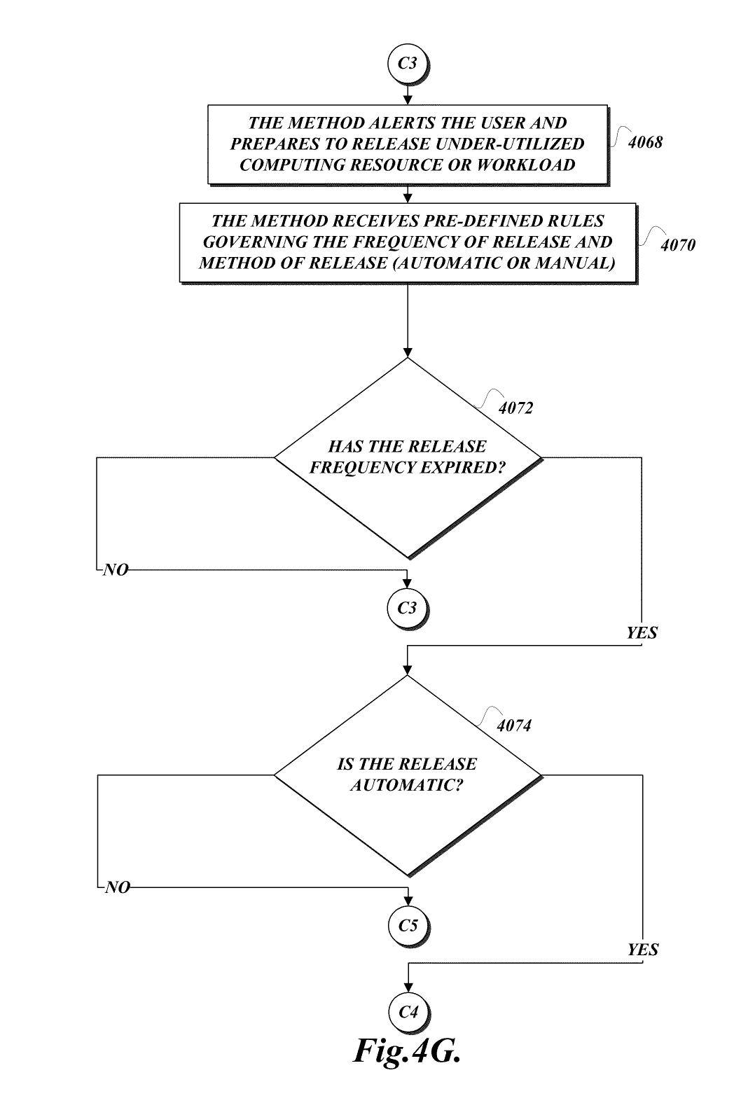

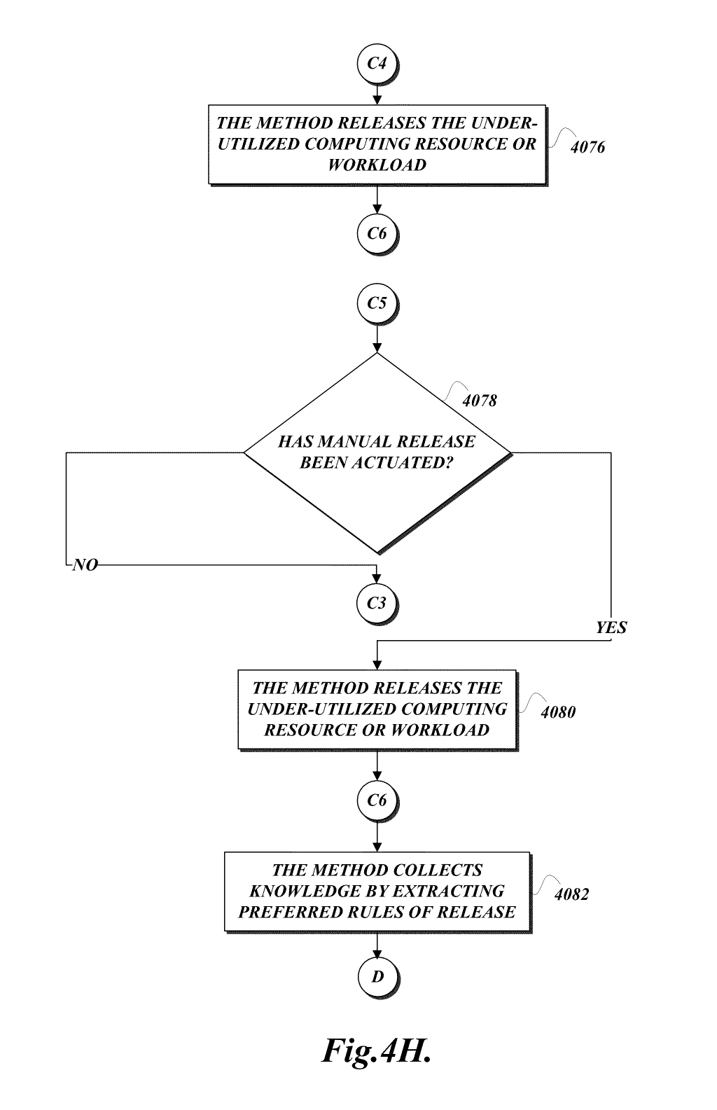

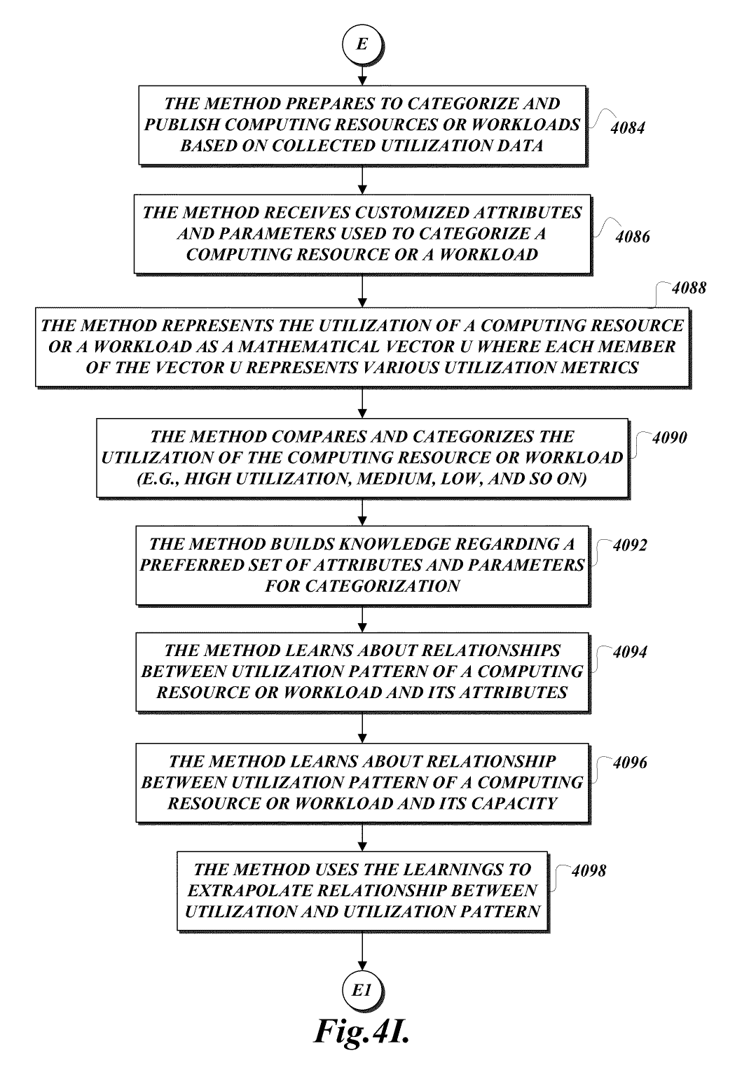

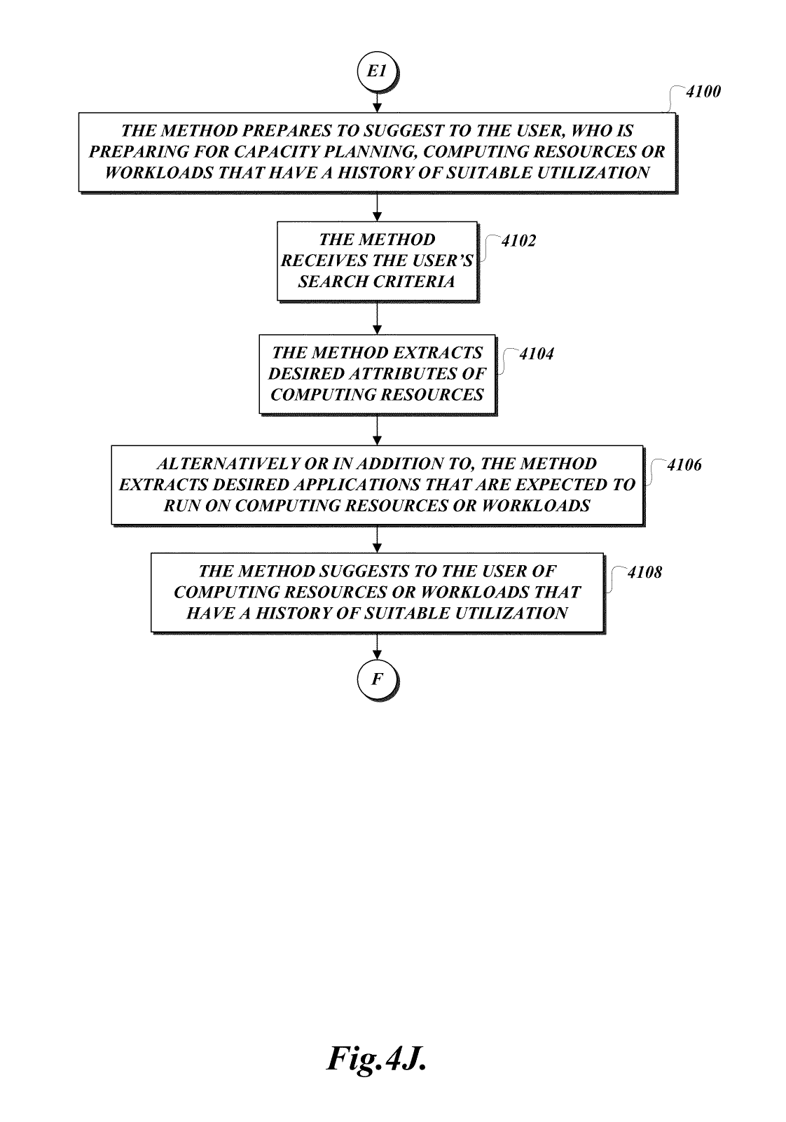

FIGS. 4A-4J illustrate a software method 4000 for monitoring and bettering utilization of computing resources or workloads via pieces of hardware. The method 4000 includes one or more features, in a set of embodiments, for alerting a user regarding underutilized resources: monitoring user resource utilization at various granularities; analyze and generating insight from usage across users, communities and federation; profiling workloads based on resource utilization; generating utilization data based on pre-defined templates; alerting users on resource underutilization (using communication technologies such as SMS, email, inline, chat); providing a collection of tools for users to define underutilized resources; acting on behalf of the user to release underutilized resources according to pre-defined rules; providing a collection of tools to enable users to define rules and templates so as to assist report generation and resource release; quantifying underutilization into a cost metric that can be proactively managed during subsequent planning stages; and/or quantifying underutilization as a credit (definable by a vendor who offers such a credit that can be transferable or exchangeable among different parties for actual or predicated market value; or instead of the vendor-defined credit, the generally recognized carbon credit may be used) that can be proactively factored into during subsequent planning stages. The method 4000 includes one or more features, in another set of embodiments, regarding suggesting cost efficient alternatives to the user during the capacity planning phase: categorizing workloads based on resource utilization; publishing workloads under various categories; suggesting cost-effective workloads matching a user's search criteria; learning the relationship between resource attributes and their utilization pattern; learning the relationship between workload capacity and the utilization pattern of the constituent resources; and/or extrapolating the relationship between resource utilization and applications that run on the resources.

Returning to FIG. 4A, from the start block, the method 4000 proceeds to a set of method steps 4002, defined between a continuation terminal (“terminal A”) and an exit terminal (“terminal B”). The set of method steps 4002 describe monitoring the utilization of one or more computing resources or one or more workloads. From terminal A (FIG. 4B), the method 4000 proceeds to block 4008 where, responding to a user computing request, the method allocates a computing resource or workload to the user and causes it to transition through its life cycle. At block 4010, the method receives a defined range of resource utilization bounded by a minimum, a maximum, and a desired utilization matrix. At block 4012, if no defined range of resource utilization is provided, the method uses default values. At block 4014, the method receives a threshold duration to monitor utilization, and if no threshold duration is specified, a default value is used. The method then receives at block 4016 a monitoring time period. If monitoring the time period is zero, the method uses a default monitoring time period. See block 4018. At block 4020, the method prepares to monitor the utilization of one or more computing resources or of one or more workloads at various computing granularities. The method then continues at another continuation terminal (“terminal A1”).

From terminal A1 (FIG. 4C), the method collects utilization data of one or more servers (virtualization host server level) at regular or irregular intervals. See block 4022. At block 4024, the method collects utilization data of one or more virtual machines on each server at regular or irregular intervals. The method collects at block 4026 utilization data of one or more processes running within one or more virtual machines at regular or irregular intervals. At block 4028, unless the user specifies a set of attributes to monitor, the method collects utilization data for CPU utilization, RAM utilization, network latency, and so on. The method 4000 then proceeds to decision block 4030 where a test is performed to determine whether the monitoring time period has expired. If the answer to the test at decision block 4030 is YES, the method continues to exit terminal B. If the answer to the test at decision block 4030 is NO, the method skips back to block 4022 where the above-identified processing steps are repeated.

From terminal B (FIG. 4A), the method 4000 proceeds to a set of method steps 4004, defined between a continuation terminal (“terminal C”) and an exit terminal (“terminal D”). From terminal C (FIG. 4D), the method 4000 proceeds to block 4032 where the method receives collected utilization data of one or more computing resources or one or more workloads. The method at block 4034 receives one or more templates. The method then profiles one or more computing resources or one or more workloads using one or more templates on the collected utilization data to adduce utilization patterns. See block 4036. At block 4038, the method further profiles the utilization patterns into various time periods, such as hourly, daily, weekly, monthly, yearly, and so on. The method at block 4040 prepares to report collected utilization data and profiled utilization patterns. The method then uses a default reporting format unless the method receives a desired reporting format. See block 4042. At block 4044, if no defaulting reporting format is available, the method uses knowledge to extract a preferred reporting format from the collected utilization data. At block 4046, the method uses a default delivery mechanism unless the method receives a specified delivery mechanism. The method then continues to another continuation terminal (“terminal C1”).

From terminal C1 (FIG. 4E), if no default delivery mechanism is available, the method uses knowledge to extract a preferred delivery mechanism from the collected utilization data. See block 4048. At block 4050, the method uses a default reporting frequency unless the method receives a specified reporting frequency. If no default reporting frequency is available, the method uses knowledge to extract a preferred reporting frequency from the collected utilization data. See block 4052. At block 4054, the method uses a default list of recipients unless the method receives a specified list of recipients. At block 4056, if no default list of recipients is available, the method uses knowledge to extract a preferred list of recipients from the collected utilization data. The method then prepares the report for various time periods, such as hourly, daily, weekly, monthly, yearly, and so on. See block 4058. The method then continues to another continuation terminal (“terminal C2”).

From terminal C2 (FIG. 4F), the method receives predefined rules to detect underutilization of one or more computing resources or one or more workloads. See block 4060. At decision block 4062, a test is performed to determine whether there is underutilization. If the answer to the test at decision block 4062 is YES, the method continues to another continuation terminal (“terminal C3”). Otherwise, if the answer to the test at decision block 4062 is NO, the method proceeds to block 4064 where the method uses knowledge extracted from collected utilization data to detect underutilization using sub-optimal analysis for a time period longer than the threshold duration. The method then proceeds to decision block 4066 where another test is performed to determine whether there is underutilization. If the answer to the test at decision block 4066 is YES, the method continues to terminal C3. Otherwise, if the answer to the test at decision block 4066 is NO, the method proceeds to another continuation terminal (“terminal F”) and terminates execution.

From terminal C3 (FIG. 4G), the method proceeds to block 4068 where the method alerts the user and prepares to release the underutilized computing resource or workload. At block 4070, the method receives predefined rules governing the frequencies of release and method of release (automatic or manual and so on). The method then proceeds to decision block 4072 where a test is performed to determine whether the release frequency has expired. If the answer to the test at decision block 4072 is NO, the method continues to terminal C3 and skips back to block 4068 where the above-identified processing steps are repeated. If the answer to the test at decision block 4072 is YES, the method 4000 proceeds to another decision block 4074 where another test is performed to determine whether the release is automatic. If the answer to the test at decision block 4074 is NO, the method proceeds to another continuation terminal (“terminal C5”). Otherwise, if the answer to the test at decision block 4074 is YES, the method proceeds to another continuation terminal (“terminal C4”).

From terminal C4 (FIG. 4H), the method 4000 proceeds to block 4076 where the method releases the underutilized computing resource or workload. The method then proceeds to another continuation terminal (“terminal C6”). From terminal C5 (FIG. 4H), the method 4000 proceeds to decision block 4078 where a test is performed to determine whether manual release has been actuated. If the answer to the test at decision block 4078 is NO, the method proceeds to terminal C3 and skips back to block 4068 where the above-identified processing steps are repeated. Otherwise, if the answer to the test at decision block 4078 is YES, the method proceeds to block 4080 where the method releases the underutilized computing resource or workload. The method then continues to terminal C6 and further continues to block 4082 where the method collects knowledge by extracting preferred rules of release. The method then continues to exit terminal D.

From terminal D (FIG. 4A), the method 4000 proceeds to a set of method steps 4006, defined between a continuation terminal (“terminal E”) and another continuation terminal (“terminal F”). The set of method steps 4006 categorizes and suggests computing resource configurations that have a utilization history suitable to users. From terminal E (FIG. 4I), the method prepares to categorize and publish computing resources or workloads based on collected utilization data. See block 4084. At block 4086, the method receives customized attributes and parameters used to categorize a computing resource or workload. The method at block 4088 represents the utilization of a computing resource or workload as a mathematical vector U where each member of the vector U represents various utilization matrixes. At block 4090, the method compares and categorizes the utilization of computing resource or workload (such as high utilization, medium, low, and so on). The method at block 4092 builds knowledge regarding a preferred set of attributes and parameters for categorization. At block 4094, the method learns about relationships between a utilization pattern of a computing resource or workload and its attributes. The method next learns about relationships between a utilization pattern of a computing resource or workload and its capacity. See block 4096. At block 4098, the method uses the learning to extrapolate the relationship between utilization and utilization patterns. The method then continues to another continuation terminal (“terminal E1”).

From terminal E1 (FIG. 4J), the method prepares to suggest to the user (such as through the user agent 104) who is preparing for capacity planning, the computing resources or workloads that have a history of a suitable utilization period. See block 4100. At block 4102, the method receives the user search criteria. At block 4104, the method extracts desired attributes of computing resources. Alternatively, or in addition to, the method at block 4106 extracts desired applications that are expected to run on computing resources or workloads. At block 4108, the method suggests to the user computing resources or workloads that have a history of suitable utilization. The method then continues to terminal F and terminates execution.

As an example of suggestion by the method 4000, consider the example of the Drupal Content Management System mentioned previously and the workloads mentioned previously. For the sake of simplicity, suppose that all workloads were used to implement a Drupal Content Management system. The method 4000 monitors the usage pattern of these workloads, learning the relationship between resource usage and resource attributes. Based on this learning, the method 4000 understands that a resource makeup of a first workload has better utilization than a second workload for a Drupal workload. Using this learning, when a future user searches for resources to implement a Drupal or a content management workload, the system recommends a workload similar to the first workload rather than the second workload. This choice of a high-utilization workload enables user to choose low cost alternatives from the planning stage on.

Other embodiments include analytics and business intelligence federated computing environments. In these embodiments, transactions in the federated on-demand computing environments are logged and annotated with the types of workloads executed by different federated data centers, as well as their performance in delivering a reliable computing environment for the workloads. In these embodiments, the method 4000 is enabled to collect business intelligence and derived data and information from the federation server's transaction logs to produce metrics so as to facilitate utilization of resources: computing resource utilization and mining; learning computing templates and compute patterns that enable stakeholders to reuse/learn from their computing requirements and environments; providing utility-based metrics for data center computing efficiencies; providing federation as a mechanism to measure and quantify green credits for providers and consumers; providing resource consumer/provider ratings and rankings; providing rating measures and metrics for resource usage and provisioning; and/or providing data center operations insights and analysis.

While illustrative embodiments have been illustrated and described, it will be appreciated that various changes can be made therein without departing from the spirit and scope of the invention.

1. A method for managing utilization of resources or workloads, comprising:
monitoring utilization of a computing resource or workload;
alerting a user of underutilization of the computing resource or workload; and
either releasing or not releasing the computing resource or workload that is underutilized based on a set of releasing rules.

2. The method of claim 1, further comprising receiving a monitoring time period.

3. The method of claim 1, further comprising collecting utilization data from various granularities selected from a group consisting essentially of servers, virtual machines, processes, and computing attributes.

4. The method of claim 1, wherein the act of alerting includes alerting the user using communication selected from a group consisting essentially of SMS, e-mail, inline communication, and chat.

5. The method of claim 1, wherein the act of either releasing or not releasing includes receiving the releasing rules selected from a group consisting essentially of rules governing the frequency of release and method of release.

6. The method of claim 1, further comprising profiling the computing resource or workload using one or more templates on collected utilization data to adduce utilization patterns.

7. The method of claim 1, wherein the act of alerting is executed using utilization rules that define underutilization.

8. The method of claim 1, further comprising receiving reporting rules selected from a group consisting essentially of reporting format, delivery mechanism, reporting frequency, and list of recipients.

9. The method of claim 8, further comprising reporting utilization data.

10. The method of claim 1, further comprising quantifying underutilization into a quantity selected from a group consisting essentially of a cost metric and a credit.

11. The method of claim 1, further comprising categorizing the computing resource or workload based on utilization data.

12. The method of claim 1, further comprising publishing the computing resource or workload into a category of utilization.

13. The method of claim 1, further comprising providing a suggestion to the user regarding a computing resource or a workload that has a history of suitable utilization matching the user search criteria.

14. The method of claim 1, further comprising learning about a relationship between attributes of the computing resource or workload and a utilization pattern.

15. The method of claim 1, further comprising learning about a relationship between capacity of the workload and utilization pattern of one or more computing resources that composed the workload.

16. The method of claim 1, further comprising extrapolating a relationship between utilization of the computing resource or workload and applications that run on the computing resource or workload.

17. A system for managing utilization of resources or workloads, comprising:
a monitoring agent, being executed on a piece of hardware, to monitor utilization of a computing resource or workload;
an alerting agent, being executed on the piece of hardware or another piece of hardware, to alert a user of underutilization of the computing resource or workload; and
a releasing agent, being executed on the piece of hardware or another piece of hardware, to either release or not release the computing resource or workload that is underutilized based on a set of releasing rules.

18. A computer-readable medium, which is non-transitory and on which computer-executable instructions are stored to implement a method for managing utilization of resources or workloads, comprising:
monitoring utilization of a computing resource or workload;
alerting a user of underutilization of the computing resource or workload; and
either releasing or not releasing the computing resource or workload that is underutilized based on a set of releasing rules.

19. The computer-readable medium of claim 18, further comprising categorizing the computing resource or workload based on utilization data.

20. The computer-readable medium of claim 18, further comprising providing a suggestion to the user regarding a computing resource or a workload that has a history of suitable utilization matching the user search criteria.
